(19) United States
(12) Patent Application Publication
(10) Pub. No.: US 2008/0243859 A1
(43) Pub. Date: Oct. 2, 2008

(54) Information Self-Storage System

(75) Inventor: Michael J. Lapointe, Poughkeepsie, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/690,897

(22) Filed: Mar. 26, 2007

(51) Int. Cl. G06F 17/30

(52) U.S. Cl. 707/10; 707/E17.032

(57) ABSTRACT

An information self-storage system and a method of storing digital information in and retrieving that information from a self-storage system are described. The system comprises a network of storage devices, a group of distributed servers for managing use of the storage devices, and a plurality of distributed input terminals for receiving from users portable data media. The input terminals read digital information from portable media and download the read digital information to the servers for storage on the storage devices. With authorization of a person, after one of the input terminals reads and inputs the data from the data storage media, the input terminal may remove the information from the data storage media. The media is then available as empty or refreshed to the person. This allows a person using this system and the input terminal to have the data storage media returned fully or partially empty.

### BACKGROUND OF THE INVENTION

1. Field of the Invention

This invention generally relates to data management, and more specifically, relates to a method and system for receiving and storing large amounts of digital data from a group of people. Even more specifically, the preferred embodiment of the invention relates to such methods and systems that are well suited for use with large numbers of people, such as the general public.

2. Background Art

Over the last several years, the public's use of digital data has grown enormously. A number of factors have contributed to this growth. First, over the last few years, personal computers have become very common. There has been a dramatic increase in personal computers for household use, including, for financial, educational, and entertainment purposes. In addition, local and wide area networks of personal computers are now often used in corporations, businesses and other enterprises. As a result of this very significant expansion of the use of personal computers, more and more digital data are generated, used and stored.

Also, more and more information is in the form of digital data. For example, music, pictures, and videos are now commonly stored and transmitted in the form of digital data. Digital cameras, as one more specific example, are becoming ubiquitous. Other forms of media containing digital information are also now very common.

Due to the incredible amount of digital data in use today, individuals, businesses and other enterprises may have difficulty storing all the digital data they need or want. Compact discs, memory cards and hard drives hold a lot of information, but the amount and size of digital information is growing to the point where these traditional storage devices are simply inadequate for many individuals and businesses. The use of traditional physical media to store digital data may also present problems with security, access ad protection. As a result, there is a clear and growing need for publicly accessible, user-friendly electronic data storage.

### SUMMARY OF THE INVENTION

An object of this invention is to improve methods and systems for storing information.

Another object of the present invention is to provide a comprehensive system for electronic information storage.

A further object of the invention is to provide an electronic information storage system that enables users to upload information to, and to download information from, a network storage media, that securely stores the information and that provides the user with ready, on demand access to the information.

These and other objectives are attained with an information self-storage system and a method of storing digital information in and retrieving that information from a self-storage system. The information self-storage system comprises a network of distributed storage devices for storing data; and a group of distributed servers connected to the storage devices for managing use of the storage devices, including storing data on and retrieving data from the storage devices. The self-storage system further comprises a plurality of distributed input terminals for receiving from users portable data media having digital information stored thereon, and for receiving from the users user identifications and user authentication information. The distributed input terminals process said user identifications and user authentication information to identify authenticated users and to associate each authenticated user with a specific data storage account. The input terminals read digital information from portable media received from authorized users and download the read digital information to the servers for storage on the storage devices in accordance with the data storage account associated with the authorized users. The storage devices, the servers and the input terminals are connected together by a communications network. This network may be, for example, the Internet, or in alternative embodiments, may be, or include, a Wide Area Network or a local Area Network.

In a preferred embodiment, selected information stored in the storage device is available on demand to users of the system authorized to access said selected information. Also, as an option, the servers may store software applications for managing security of the data stored on the storage devices and to enable the input terminals to interface with the users, and the servers may send copies of said software applications to the input terminals for use by said input terminals.

In addition, these software applications may include instructions for the input terminals to bill the users for use of the information self-storage system. For example, each user may be billed on the basis of (i) each account the user has with the system, (ii) each transaction the user has with the system, or (iii) the amount of information the user stores in the system.

The storage and retrieval of the electronic information may happen on line or with another network of public or business access points into the system. Users may be billed in a variety of ways for using the ISS system. For example, users may be billed a fixed or defined amount per account, per transaction, or per amount of information involved. Costs may also be based on the extent to which access to the system is available to the user. For instance, users may be charged a premium for on demand access to for continuous, 24-hour access. User applications such as data mining could be used and billed separately, as provided by the clients.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates an Information Self-Storage (ISS) system embodying the present invention.

FIG. 2 is a block diagram showing components of an example of an Automated Information Machine (AIM) that may be used in the system of FIG. 1.

FIG. 3 is a more detailed diagrammatic illustration of components of the Automated Information Machine.

### DETAILED DESCRIPTION OF THE PREFERRED EMBODIMENTS

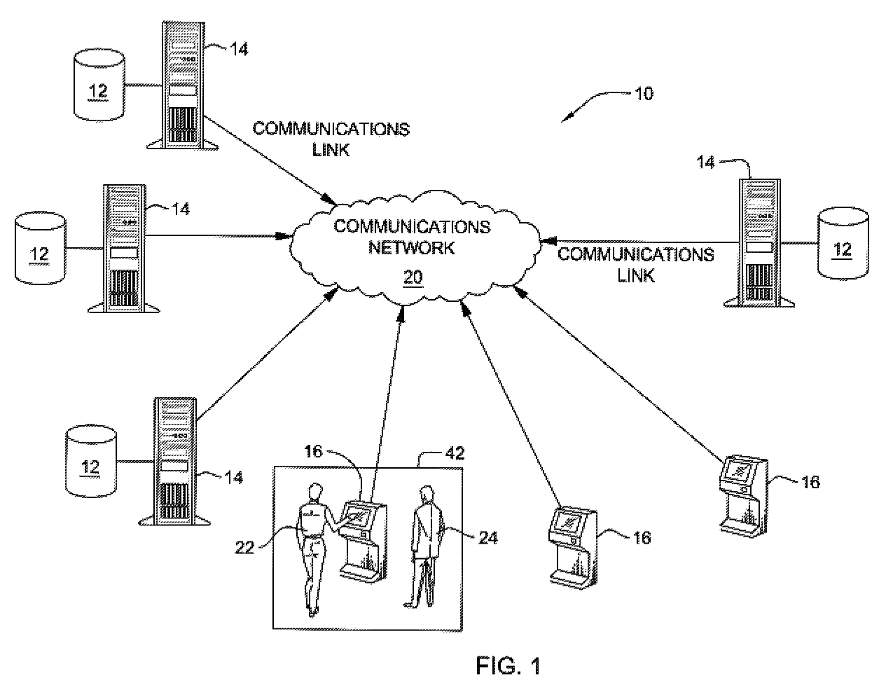

FIG. 1 shows generally an Information Self-Storage (II) system, referenced at 10, embodying the present invention. Generally, system 10 comprises a network of storage devices 12, servers 14 to manage use of those storage devices, a plurality of interface machines 16, and a communications network 20 that connects machines 16 with servers 14 and storage devices 12. FIG. 1 also shows a user 22 of system 10 and a consultant 24 to help that user.

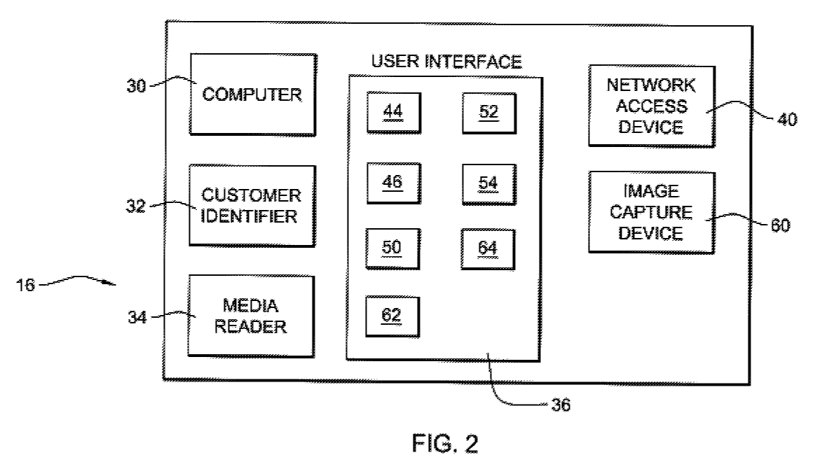

In the preferred embodiment of the invention, the interface machines 16 are Automated Interface Machines (AIMS). FIG. 2 shows, as an example, an AIM in more detail, and as illustrated in this Figure, AIM preferably includes a computer 30, a customer identifier 32, a media reader 24, a user interface 36, and a network access device 40.

With reference to FIG. 1, storage devices 12 are provided for storing data, and any suitable storage devices may be used in the practice of this invention. For instance, storage devices 12 may be or include magnetic tape cassettes, digital videotapes, solid state RAMs, and other data storage media.

Servers 14 are provided to manage use of storage devices, and in particular, to store data into and to retrieve data from those storage devices. In the depicted example, each server 14 is connected to a data storage unit 12 and to network 20; and servers 14 may provide data, such as boot files, operating system images, and applications to clients, including data storage devices and interface machines 16. Any suitable data processing systems may be used as servers 14. For instance, each server may be a symmetric multiprocessor (SMP) system including a plurality of processors connected to a system bus. Alternatively, a single processor system may be employed.

Network 20 connects machines 16 with servers 14 and storage devices 12 to transmit data and information between and among machines 16, servers 14, and storage devices 12. In the depicted example, network 20 is the Internet, which is a worldwide collection of networks and gateways that use the TCP/IP suite of protocols to communicate with one another. The core of the Internet is a backbone of high-speed data communications links between major nodes or host computers including thousands of commercial, government, education, and other computer systems that route data and messages. As will be understood by those of ordinary skill in the art, network 20 may be implemented an another type of network such as, for example, an intranet, a local area network (LAN), or a wide area network (WAN).

Interface machines 16 act as the interface between users of system 10 and servers 14 and storage devices 12. In a preferred embodiment, interface machines 16 are similar to Automated Teller Machines (ATMs) except that the interface machines 16 receive and output information. Interface machines 16 may receive information from, and output information onto, many specific types of devices, including compact disks, digital video recorders, optical disks, and floppy disks. Preferably, a keypad may be provided to allow user input at the interface machine. Also, machines 16 may be provided with a graphical user interface to enable other user input at the machines.

In the operation of system 10, a person 22 brings data storage media to one of the machines 16; and for example, this storage media could be a stack of memory cards or diskettes. Person 22 preferably then inputs into the machine 16 user identification and user authentication to associate the user with a specific data storage account of the ISS 10. Machine 16 reads information off the storage media and inputs that information into the ISS system 10. Servers 14 then manage the transfer of data into storage devices 12. In order to retrieve information from system 10, a user goes to one of the machines 16 and, after appropriate anthorization and authentication, uses the machine to get the desired information back.

With authorization of a person 22, after machine 16 and System 10 reads and inputs the data from the data storage media, the Machine 16 will remove the information from the data storage media, providing the media is configured to allow removal. The media is then available as empty or refreshed to person 22.

This allows a person 22 using this system 10 and machine 16 to have the date storage media returned fully or partially empty after the information is read off the media and inputted in system 10. For example, someone traveling with a digital camera may fill the borage media with photographs and be unable to take more pictures due to full media. Instead of procuring new media or deleting items from the media, using machine 16 allows the information to be read and removed. The user has the media information read into the system, and retrieves the now fully-empty or partially-empty media from machine 16, available to use to take more pictures.

If desired, any suitable procedure may be used to bill for the use of system 10. For instance, users may be billed a fixed or defined amount per account, per transaction, or per amount of information involved. Costs may also be based, in part, of the type of access, such as on demand access, that the user has to the information in system. Also, a physical office 42 could be provided where information is brought in, and where an information consultant 24 loads and then stores the data. The consultant may also be used to retrieve, or to help retrieve, information from system 10.

With reference to FIG. 2, interface machine 16 includes a computer, represented at 30, a customer identifier, represented at 32, and a multimedia interface, represented at 36. Computer 30 is provided for executing programmed instructions and facilitating transactions. Identifier 32 is responsive to the computer for coordinating access to the storage network customer accounts. Multimedia interface 34 is responsive to the computer for providing access to the information.

AIM may be attached physically or logically to an existing automated machine such as an Automated Teller Machine (ATM) or a digital image-processing kiosk. In addition, in some embodiments) the ATM function may be contained within an apparatus with self-contained network connections (such as wireless) providing a mobile means of information download when a wired connection cannot be made but a wireless connection can be made.

In some embodiments, the AIM function may be contained within an apparatus with self-contained power connections (such as a rechargeable battery), providing a mobile means of information download when a wired power connection cannot be made. By maintaining a system of spares and regular battery rotation, then an unwired power connection, cordless function may be achieved.

In some embodiment, the AIM function may be contained within an apparatus with a standard input/output connection, such as a USB connection, and software function which is partially loaded on the device into which the USB connector is plugged.

In addition, in some embodiments, the AIM contains internal storage to allow transactions to occur (with customer approval) in the event of a network communication breakdown. The AIM process may communicate with internal storage to allow downloading to internal storage at the time of a customer transaction, and later downloading to the storage network when the network connection is available.

With reference again to FIG. 2, the example AIM 12 is shown as including thereon a user interface generally indicated at 36. User interface 36 includes one or more input devices and output devices. Input devices may be used by the operator of the machine to provide information or instructions to the machine. Output devices include devices for providing information and instructions to a user. In this exemplary embodiment, user interface 36 includes an output screen 44, which serves an output device. User interface 36 of the exemplary embodiment further includes a speaker, schematically indicated at 46, for providing audible outputs to a user.

User interface 36 may further includes a card reader schematically indicated at 50. The card reader in the exemplary embodiment is operative to read cards or other articles provided to the machine by a user that may include information that identifies the user, a user's account or other information. User interface 36 further includes function keys 52. Function keys 52 are positioned adjacent to screen 44 and enable a user to select options that may be presented to the user visually through the screen. A further input device in the exemplary embodiment includes a keypad 54. In this exemplary embodiment, keypad 54 includes an alphanumeric keypad as well as certain function keys.

The AIM of FIG. 2 also includes an image capture devise 60 that may be operative to capture images of portions of a user. This may include, for axample, capturing images of the user's face for purposes of making a record of the transaction. Alternatively, images of a user's face may be analyzed and used for purposes of identifying the user. In alternative embodiments, the image capture device may comprise an iris scanner or other biometric reader for purposes of identifying a particular user carrying out a transaction. Other input devices may also be provided on user interface 36. For instance, a fingerprint-reading device 62 is schematically represented. Fingerprint reading devices may be used in some embodiments to read fingerprint data from a user for purposes of identifying a user. It should be understood that fingerprint data, iris scan data or other biometric data may be used in some embodiments as an alternative or additional means for identifying the user. Such means may be used as a substitute for or as a check on data provided by a user to a card reader or other method for purposes of verifying the user's identity or accounts.

The example AIM 16 further includes in its user interface, a printer 64 that may be used to provide users with receipts or other data related to transactions that are conducted at the machine. It should be understood that in other embodiments, different or additional types of output devices may be provided, including printers that provide users with statements or other documents.

It should be understood that the devices discussed in connection with AIM 16 are exemplary. In other embodiments of AIMs, different types and numbers of devices may be used. Also, the type and character of the devices may depend on the particular type of AIM being operated and the character of the transaction types to be conducted.

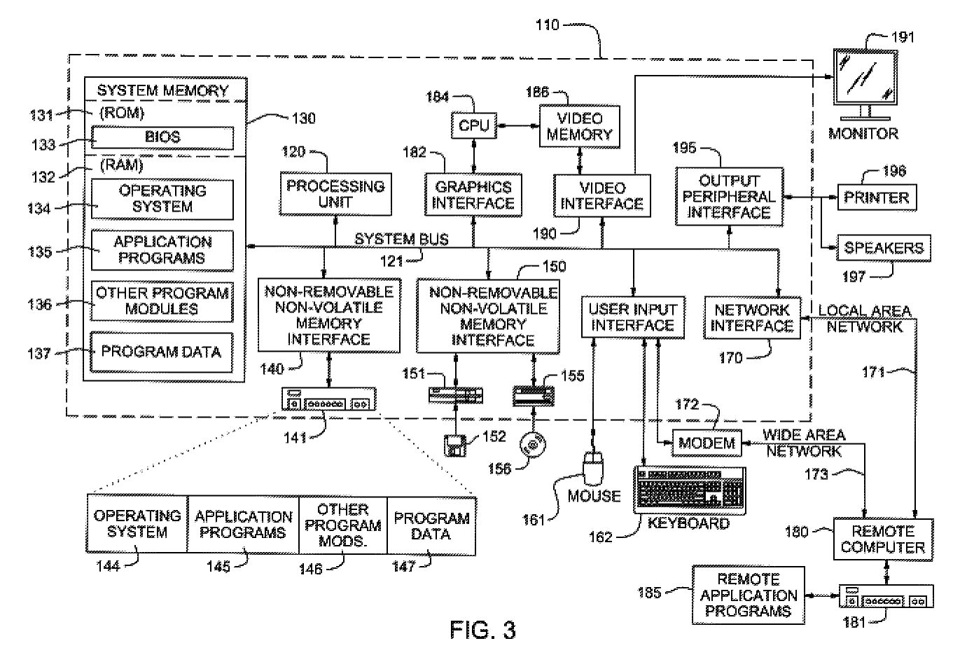

The operation of AIM 16 will be generally implemented by a computer executing a sequence of program instructions for carrying out that operation and may be embodied in a computer program product comprising media storing the program instructions. For example, FIG. 3 and the following discussion provide a more specific description of a suitable computing environment in which the operation of AIM 16 may be implemented. It should be understood, however, that handheld, portable, and other computing devices of all kinds are contemplated for use in connection with the present invention. While a general-purpose computer is described below, this is but one example, and the present invention may be implemented in an environment of networked hosted services in which very little or minimal client resources are implicated, e.g., a networked environment in which the client device serves primarily as a browser interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments.

Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs. minicomputers, mainframe computers, and the like. The invention may also be practiced ia distributed computing environments where tasks are performed by remote processing devices that are linked through a communications network or other data transmission medium. In a distributed computing environment, program modules may be located in both local and remote computer storage media including memory storage devices.

FIG. 3, thus, illustrates an example of a suitable computing system environment 100 in which the operation of AIM 16 may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 3, an exemplary system far implementing the invention includes a general purpose-computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer stamp media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be housed to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/non-removable, volatile/nonvolatile computer storage media. By way of example only, FIG. 3 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, sad magnetic disk drive 151 and optical disk drive 155 are typically connected to the system bus 121 by a removable memory interface, such as interface 150.

The drives and their associated computer storage media discussed above and illustrated in FIG. 4 provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as the above-mentioned function keys. Other devices, such as a keyboard 162 and pointing device 161, commonly referred to as a mouse, trackball or touch pad, may also be provided for user input. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191, which may be the above-mentioned output screen of AIM 16, or other type of display device is also connected to the system bus 121 via an interface, such as a video interface 190, which in turn may communicate with video memory 186. A graphics interface 182 may also be corrected to the system bus 121. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. In addition to monitor 191, computers may also include other peripheral output devices such as speakers 197 and printer 196, which may be connected through an output peripheral interface 195.

As indicated above, the computer 110 may operate in a networked environment, using logical connections to one or more remote computers, represented in FIG. 3 as a remote computer 180. The logical connections depicted in FIG. 3 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modern 172 or other means for establishing communications over the WAN 173, such as the Internet. The modem 172, which may be internal or external, may be connected to the system bits 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, aspects of the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. An information self-storage system, comprising:
a network of distributed storage devices for storing data;
a group of distributed servers connected to the storage devices for managing use of the storage devices, including storing data on and retrieving data from the storage devices;
a plurality of distributed input terminals for receiving from users portable data media having digital information stored thereon, for receiving from the users user identifications and user authentication information, and for processing said user identifications and user authentication information to identify authenticated users, and to associate each authenticated user with a specific data storage account, and wherein the input terminals read digital information from portable media received from authorized users and download the read digital information to the servers for storage on the storage devices in accordance with the data storage account associated with the authorized users; and
wherein the storage devices, the servers and the input terminals are connected together by a communications network.

2. An information self-storage system according to claim 1, wherein each of the input terminals, after receiving digital information from a given media received from one of the users, deletes said digital information from said given media and returns said given media to said one of the users for re-use by said one of the users.

3. An information self-storage systems according to claim 2, wherein said given media is a data memory card from a digital camera.

4. An information self-storage system according to claim 1, wherein selected information stored in the storage devices is available on demand to users of the system authorized to access said selected information.

5. An information self-storage system according to claim 1, wherein the servers store software applications for managing security of the data stored on the storage devices and to enable the input terminals to interface with the users, and wherein the servers send copies of said software applications to the input terminals for use by said input terminals.

6. An information self-storage system according to claim 5, wherein:
said software applications include instructions for the input terminals to bill the users for use of the information self-storage system; and
each user is billed on the basis of (i) each account the user has with the system, (ii) each transaction the user has with the system, or (iii) the amount of information the user stores in the system.

7. An information self-storage system according to claim 1, wherein each of the input terminals includes an output subsystem for retrieving information requested by one of the users from the storage devices, for copying said retrieved information onto an output storage medium, and for making said output storage medium available to said one of the users.

8. An information self-storage system according to claim 1, wherein each of the input terminals includes:
a processor for facilitating transactions with the users and for executing preprogrammed instructions to obtain the digital information from the users, to download said distal information to the servers, and to retrieved the digital information from the servers;
a customer identifier responsive to the processor for coordinating for each user access to the data storage devices in accordance with an account established for the user;
a multimedia interface responsive to the processor for providing access to the information in said data storage devices; and
a user interface for providing communications between the processor and the users.

9. An information self-storage system according to claim 8, wherein the user interface includes:
a display to prompt the user for input;
a means of identifying the users;
user input interface for enabling the user to input commands to the input terminal; and
wherein the communications network is the Internet.

10. A method of storing digital information in and retrieving the digital information from a self-storage system including a network of distributed storage devices, a group of distributed servers connected to the storage devices, and a plurality of distributed input terminals, the method comprising the steps of:
a user inputting into one of the input terminals a portable storage medium having given digital information thereon;
said user inputting into said one of the terminals a user identification and user authentification information to associate said user with a specific data storage account of the self-storage system;
said one of the input terminals processing the user identification and the user authentication information to authenticate said user;
said one of the input terminals receiving the storage medium, reading said given digital information thereon, and downloading said given digital information to one of the servers; said one of the servers storing said given digital information in one of the storage devices in accordance with the data storage account associated with said user;
the user inputting into a selected one of the input terminals a request to retrieve said given digital information;
said selected one of the input terminals sending said request to a selected one of the servers;
said selected one of the servers retrieving said given digital information from said one of the storage devices and uploading said digital information to the selected one of the input terminals; and
said selected one of the input terminals copying the retrieved information onto an output storage medium and making said output storage medium available to the user.

11. A method according to claim 10, comprising the further steps of said one of the input terminals, after reading said given digital information from said storage medium, deleting said given digital information from said storage medium, and returning said storage medium to the user.

12. A method according to claim 11, wherein said storage medium is a data memory card from a digital camera.

13. A method according to claim 10, comprising the further step of using the servers to manage the storage devices including storing data on and retrieving information from said storage devices, and wherein said given digital information is available on demand to said user.

14. A method according to claim 10, wherein the servers store software applications for managing security of the data stored on the storage devices and to enable the input terminals to interface with the users, and the method comprises the further step of the servers sending copies of said software applications to the input terminals for use by said input terminals.

15. A method according to claim 13, wherein:
said software applications include instructions for the input terminals to bill the users for use of the information self-storage system; and
each user is billed on the basis of (i) each account the user has with the system, (ii) each transaction the user has with the system, or (iii) the amount of information the user stores in the system.

16. A program storage device readable by machine, tangibly embodying a program of instructions executable by the machine to perform method steps for storing digital information in and retrieving the digital information from a self-storage system including a network of distributed storage devices, a group of distributed servers connected to the storage devices, and a plurality of distributed input terminals, and wherein a user inputs into one of the input terminals a portable storage medium having given digital information thereon, the method steps comprising;
said one of the input terminals receiving from the user a user identification and user authentication information to associate the user with a specific data storage account of the self-storage system;
said one of the input terminals processing the user identification and the user authentication information to authenticate said user:
said one of the input terminals receiving the storage medium, reading said given digital information thereon, and downloading said given digital information to one of the servers;
said one of the servers storing said given digital information in one of the storage devices in accordance with the data storage account associated with said user;
a selected one of the input terminals receiving from the user a request to retrieve said given digital information;
said selected one of the input terminals sending said request to a selected one of the servers;
said selected one of the servers retrieving said given digital information from said one of the storage devices and uploading said digital information to the selected one of the input terminals; and
said selected one of the input terminals copying the retrieved information onto an output storage medium and making said output storage medium available to the user.

17. A program storage device according to claim 16, wherein the method steps further comprise said one of the input terminals, after reading said given digital information from said storage medium, deleting said given digital information from said storage medium, returning said storage medium to the user.

18. A program storage device according to claim 16, wherein:
said method steps further comprise using the servers to manage the storage devices including storing data on and retrieving information from said storage devices;
said given digital information is available on demand to said user; and
the servers store software applications for managing security of the data stored on the storage devices and to enable the input terminals to interface with the users, and the method steps further comprises the servers sending copies of said software applications to the input terminals for use by said input terminals.

19. A program storage device according to claim 18, wherein said software applications include instructions for the input terminals to bill the users for use of the information self-storage system.

20. A program storage device according to claim 19, wherein each user is billed on the basis of (i) each account the user has with the system, (ii) each transaction the user has with the system, or (iii) the amount of information the user stores in the system.
